(19) United States
(12) Patent Application Publication
(10) Pub. No.: US 2014/0261024 A1
(43) Pub. Date: Sep. 18, 2014

(54) MATRIX FOR CONSTRUCTIBLE UTENSIL

(71) Applicant: EcoTensil Inc., Corte Madera, CA (US)

(72) Inventor: Peggy V. K. Cross, Larkspur, CA (US)

(73) Assignee: EcoTensil Inc., Corte Madera, CA (US)

(21) Appl. No.: 14/214,988

(22) Filed: Mar. 16, 2014

Related U.S. Application Data
(60) Provisional application No. 61/794,613, filed on Mar. 15, 2013.

(51) Int. Cl. B44C 1/24

(52) U.S. Cl. CPC B44C 1/24
USPC 101/17; 101/12

(57) ABSTRACT

A system and method for high-speed manufacturing of market-acceptable constructible utensils.

### CROSS REFERENCE TO RELATED APPLICATIONS

This application claims benefit of US patent application number 61/794,613 filed 15 Mar. 2013, the contents of which are hereby expressly incorporated by reference thereto in its entirety for all purposes.

### FIELD OF THE INVENTION

The present invention relates generally to manufacture of constructible utensils, and more specifically, but not exclusively, to high-speed rotary press “printing” of constructible utensils.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Manufacture of the product category referred to as constructible utensils is maturing. Many conventional folding spoons have useability or manufacturability issues that do not scale when making 100's to 10,000's units per minute. At current market conditions, for a single-use tasting constructible utensil, such quantities are necessary to be competitive irrespective that a single-use tasting constructible utensil may be certified to meet current compostability standards, consumer concerns, and is thus better environmentally than a plastic mini-spoon, among other advantages.

A manufacturing technique for constructible utensils uses a sheet-fed printing process as it is very good at manufacturing and managing low quantities of constructible utensils. And in its infancy, market demand could be met by sheet-fed printing. As the market has been informed and as many retailers change their standards realizing the potential advantages of paperstock constructible utensils of all types in general, and especially for a small single-use tasting constructible utensil, market demand continues to increase. A limitation on greater market acceptance from retailers can be unit cost, so manufacturing techniques are needed to cost-reduce the constructible utensil so it can gain greater entry into food tasting applications that had been reserved for small plastic spoons.

The sheet-feed printing process includes several steps for transforming a large roll of special paperstock from a mill into bundles of organized constructible utensils suitable to be delivered to distributors and retailers. Those steps include the following elements (some of which may be combined together in different steps): 1) conversion of the sheet into individual sheets; 2) feeding the sheets into a stop/go printing process that adds content, 3) die stamping process that cuts out individual constructible utensils while adding the forming the score pattern; and 4) gathering and packaging the individual utensils into the proper size. After the die stamping, the individual constructible utensils are detached from the sheet (but may need to be mechanically punched out by machine or hand) and collected into the requisite number of units to be shrink-wrapped and delivered.

Market acceptance also includes consumer acceptance, the person who actually takes the constructed utensil having a portion of foodstuff and delivers it into the mouth for consumption of the portion. The mouth is quite sensitive and a constructible utensil needs to be free from any and all sharp protrusions on the part of the constructed utensil that enters into the mouth or that the user may lick with the tongue. The mouth and tongue are sensitive to very small of irregularities and a sharp protrusion can severely reduce consumer acceptance which will have a negative impact on the retailer purchasing and using such a constructible utensil.

What is needed is a system and method for high-speed manufacturing of market-acceptable constructible utensils.

### BRIEF SUMMARY OF THE INVENTION

Disclosed is a system and method for high-speed manufacturing of market-acceptable constructible utensils. The following summary of the invention is provided to facilitate an understanding of some of technical features related to high-speed rotary printing of constructible utensils, and is not intended to be a full description of the present invention. A full appreciation of the various aspects of the invention can be gained by taking the entire specification, claims, drawings, and abstract as a whole. The present invention is applicable to other constructible utensils for non-foodstuff, as well as to high-quantity constructible paper products other than utensils.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a representative constructible utensil for high-speed manufacture;

FIG. 2 illustrates a simple die-cut system that may be produced by a rotary printing process;

FIG. 3 illustrates a set of constructible utensils made by a rotary printing process;

FIG. 4 illustrates the close-up section identified in FIG. 3;

FIG. 5 illustrates a matrix system for high-speed rotary printing;

FIG. 6 illustrates a first alternate matrix system for high-speed rotary printing;

FIG. 7 illustrates a second alternate matrix system for high-speed rotary printing;

FIG. 8 illustrates a third alternate matrix system for high-speed rotary printing;

FIG. 9 illustrates a fourth alternate matrix system for high-speed rotary printing;

FIG. 10 illustrates a fifth alternate matrix system for high-speed rotary printing;

FIG. 11 illustrates a sixth alternate matrix system for high-speed rotary printing;

FIG. 12 illustrates a constructible utensil defined by the matrix system of FIG. 10 and FIG. 11; and

FIG. 13 illustrates an alternate constructible utensil that may be defined by the disclosed matrix systems.

### DETAILED DESCRIPTION OF THE INVENTION

Embodiments of the present invention provide a system and method for high-speed manufacturing of market-acceptable constructible utensils. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

FIG. 1 illustrates a representative constructible utensil 100 for high-speed manufacture. Utensil 100 is generally representative of a wide range of constructible utensils, some of which have been illustrated and described in related patents and patent applications. These related patents and patent applications include U.S. Pat. Nos. 8,210,381, D646,529, and D651,480, and U.S. patent application Nos. 13/357,557, 61/699,808, 61/699,787, 61/712,610, 13/797,446, and concurrently filed application entitled SPOONWRAP FOR CONTAINER, U.S. application No. ______ (Attorney Docket 20226-7014), all of which are hereby expressly incorporated by reference thereto in their entireties for all purposes.

Utensil 100 includes deformable sheet 105 that defines a handle 110 and an operational element 115 in which one or more scores 120, both straight and curved, are cooperatively provided on sheet 105. The one or more scores 120 enable deformation of handle 110 and/or operational element(s) 115 to convert utensil 100 into a strong, sturdy, and functional implement sufficient to meet the required application. Utensil 100 includes a generally “bullet” shaped perimeter having a longitudinal folding axis about which utensil 100 is generally symmetric. The perimeter is formed from a shape that is about 1.25 inches wide and about 3.125 inches long (the “bullet” shaped perimeter including a generally rectangular body that is about 1.25 inches x about 2.5625 inches and a semi-disk at one end of the rectangle having a radius of about 0.5625 inches). Preferably the stock material of the preferred embodiments have a thickness ranging between about 14-18 point caliper, though other thicknesses may be appropriate, depending upon design considerations. Scores and any desired indicia may be added before, during, or after formation. Preferably any ink for the indicia are non-toxic vegetable-based dyes. Some of the embodiments benefit from a coating to improve mouth-feel and/or provide a moisture-barrier to extend use for constructible utensils, such as those expected to be used for minutes instead of seconds. As noted, other sizes, configurations, and arrangements for utensil 100 are within the scope of the present invention.

In one embodiment, the unconstructed utensil is provided on a planar sheet made of the requisite material (i.e., an appropriately green/sustainable material) that may be processed to enhance function (e.g., coated with environmentally appropriate material) to resist premature degradation during use (e.g., a moisture-barrier) or it may be manufactured of a moisture-barrier material (e.g., calcium carbonate), collectively a coating, or inherent characteristic or other moisture protection system is referred to as moisture-barrier property. Thus, quantities of the unconstructed material achieve a far greater packing density as compared to pre-constructed utensils, which saves money on shipping and storage because of the smaller cube size. For many applications, handle 110 and operational elements 115 are minimalist in material cost while maximizing structural strength and user-experience consistent with the intended use all the while having a smaller carbon footprint.

Handle 110, typically with one or more curved scores 120 that define a folding axis 125, is operated by bringing lateral portions closer together out of the plane (e.g., folding or otherwise deforming) handle 110 along one or more curved scores 120. This folding induces a responsive distortion/deformation of operational element 115 to create the desired functional element. Curved score(s) 120, in cooperation with the structural organization and composition, produce a constructed utensil that meets or exceeds performance of conventional preformed disposable/single-use utensils. This provides a superior option over conventional constructed utensils because the user gains the advantage of an improved single-use application while the utensil is eco-friendly as it has a minimalist design that is effective and capable of being made compostable and/or recyclable with recyclable, sustainable, renewable resources. These constructible utensils may be particularly configured for specific applications, including tasting, stirring, spreading, consuming harder/firmer foodstuffs, “fork-like” utensil, and the like.

Manufacturers have an option of configuring the base material, the periphery boundary, the placement and orientation of scores, and any coating to customize the final design in a wide variety of ways. As further explained herein, the user-constructible utensils include tasters, spreaders, stirrers that can have appropriately shaped handles and operational elements (e.g., bowls for a tasting spoon) that have the desired capacity, shape, and mouth-feel. Some bowls may have a deep configuration for more capacity while others may be shallower and sturdier to serve dense/hard foodstuff (e.g., ice cream). The fundamental teachings herein are adaptable to a wide-variety of user-constructible utensils for a wide-variety of tasks. In some cases, the utensil doubles as a dispensing mechanism, in lieu of a cup, which is particularly important for applications that use a utensil along with a cup and/or plate/napkin, cracker, or the like, providing valuable cost-savings.

FIG. 2 illustrates a die-cut system 200 that may be produced by a rotary printing process. Die-cut system 200 produces a matrix 205 defining a set of constructible utensils 210 each cycle. In a rotary die-cutting process, a roll of appropriate foundation material (e.g., paperstock) of the appropriate width and thickness is fed into a rotary press as a web. That rotary press uses a rotary die to print, score, and cut the web as desired. The rotary die includes a number of steel rules that define each utensil 210 by embossing the scores and cutting the perimeter.

For ease of illustration and to simplify the discussion, matrix 205 is illustrated as defining 3 rows (in one column) of utensils 210. In actual practice, a number N of rows is defined in matrix 205 each cycle. In this system, matrix 205 has a minimum width of the collective width of the N number of utensils plus the collective margin surrounding the utensils. This matrix width defines a width of the web.

In system 200, each utensil 210 is completely independent of matrix 205 after the cutting process. An output of the rotary process from system 200 may include an unbroken matrix 205 having holes where each utensil 210 was formed along with N number of rows of individual utensils 210, N in actual use is 6 or more. The rotary press may produce the N rows of individual utensils 210 so quickly that utensils 210 of the same row overlap a previous utensil just as they are overlapped by the next subsequent utensil. As the speed increases the overlap may be almost complete where one is almost perfectly aligned with its bottom one.

Ideally, the rotary press would continue to quickly produce the N separate rows of discrete utensils that would be conveniently and efficiently collected, stacked, and packaged as desired. Unfortunately, system 200 is not ideal. To minimize wasted material in matrix 205 and achieve one of the goals of cost reduction, the rows need to be very close to each other. The closeness of the rows means that invariably the N separate rows begin to merge as individual ones of utensils 210 in a row begin to fishtail and come out of alignment. The effect is magnified in that it is common to use a moisture-barrier or coating to improve mouth feel, protect against premature degradation, and the like and that coating can make utensils 210 slippery which promotes the fishtailing. When enough utensils 210 have fishtailed or the N rows have otherwise lost their orderly character promised in the ideal situation and become one large pile on a conveyor belt, the process breaks down as the mass of individual utensils 210 becomes unmanageable.

To counter the fishtailing, one solution includes running the rotary press as slow speed which is unacceptable as the cost-reduction of system 200 is at least premised on high-speed operation. Another solution is to attempt to insert physical dividers between each row. In order to add these dividers, the spacing between each row must be increased which adds to the costs. If the dividers were effective, it could produce an acceptable result. But to keep the individual utensils in each row from catching and hanging on the dividers (the dividers do not prevent the fishtailing but seek to prevent the fishtailing from chaotically merging into an adjoining row), the row spacing needs to be further increased beyond what is required to insert the rows thus the divider solution will not work, especially as printing speeds increase which tends to cause even more fishtailing.

Another characteristic of the rotary die that influences the printing of constructible utensil 210 is detailed later. An introduction to this characteristic is that the rotary die can influence the pattern of the scores. When comparing the score pattern of utensil 100 against the score pattern of utensil 210, the merging/converging score pattern of utensil 100 is replaced with distinct individual score elements. One reason for this is that the steel rules of the rotary die do not often lend themselves to creating and forming a converging, merging, and continuing score pattern as shown in FIG. 1. When it is possible to do so, the score pattern is often not symmetric which can adversely affect the folding and constructing of the constructible utensil. Further, one of the problems with a rotary die that is used to create the score pattern of FIG. 1 is that the die is subjected to greater wear and tear and has a significantly reduced lifetime between repair/replacement as compared to a die that produces the score pattern of FIG. 2. Reducing the repair/replacement costs lowers the unit cost of the constructible utensil produced from the rotary press.

FIG. 3 illustrates an alternate die-cut system 300 that may be produced by a rotary printing process to create a matrix 305 defining a plurality of constructible utensils 310 in a set 315. Set 315 has a completely cut outer perimeter 320 formed by a collection of the steel rules of the rotary die. In this way, set 315 is completely detached from matrix 305 with all constructible utensils 310 of the N rows connected to the nearest adjacent utensil 310 by a series of nicks 325. Each nick 325 is a very narrow uncut line (a minimum connection that is less than 1/32^{th} inch thick and most preferably the smallest reliable connection width possible) that maintains a physical connection and the space between nicks 325 is cut by the die collecting forming an inner perimeter. In FIG. 3, nicks 325 are all on lateral edges of utensil 310 as they are used in between utensils to link them all into set 315, but they are distributed toward the handle and away from the operational element (e.g., the bowl) as described below.

The use of nicks 325 achieves a goal of holding all the N rows of constructible utensils 310 together into set 315 and thereby prevents the cross-entanglement described in the context of FIG. 2. In this way, each set 315 is neatly stacked and a mechanical separation process (machine or by hand) is easily able to separate the individual constructible utensils 310 and allow them to neatly and efficiently stacked, counted, and packaged. A further advantage is that the sets 315 may be formed at very high-speed achieving one of the goals of cost-reduction.

Unfortunately, a feature of the rotary die that influenced the change in score pattern described above creates a consumer concern. As noted, a consumer can be concerned with sharp protrusions that enter the mouth or that make contact with the tongue. Nicks 325 are one source of sharp protrusions after set 315 is separated into individual constructible utensils 310. As seen in FIG. 3 however, it is possible to move nicks 325 away from the operational element and toward the handle. (The operational element may include a bowl-portion defined by the scores when the utensil is folded, the bowl-portion holding the foodstuff and is that part that is placed into the mouth).

However, in the formation of outer perimeter 320, a plurality of steel rules are used to cut individual segments. Where one steel rule abuts another steel rule to continue a cut, the two steel rules are unable to create a smooth transition from one rule to the other. FIG. 3 identifies an detailed exploded view of a region 330 where two such steel rules come together and abut.

A first outer perimeter segment 335 formed by one steel rule abuts a second outer perimeter segment 340 formed by another steel rule. In system 300, an inner perimeter segment 345 joins the two outer perimeter segment and produces one or more step discontinuities 350. Step discontinuity 350 is another type of sharp protrusion. Unfortunately in system 300, step discontinuity 350 is formed right at the bowl portion and creates an implementation of constructible utensil 310 that is unacceptable for most users when consuming foodstuff. In some implementations, each constructible utensil 310 will be formed with a step discontinuity 350 at each similar location producing an undesirable sharp protrusion on each side of each bowl-portion.

FIG. 4 illustrates a close-up of region 330 identified in FIG. 3 to aid in visualization of step discontinuity 350. The sharp protrusion produced can be quite slight and printers do not appreciate the potential concern as high-speed rotary printing had not been used for printing and manufacturing of constructible utensils before, and because the lack of understanding of the sensitivity of the mouth and tongue with regard to sharp protrusions as slight as formed from the indicated abutment of adjacent die-cutting elements (e.g., the steel rules).

FIG. 5 illustrates a matrix system 500 for high-speed rotary printing of marketable constructible utensils 505 defined by a matrix 510. Matrix 510 includes a web element 515 disposed between adjacent constructible utensils 505 that may be as narrow as ⅛″ and about 2″ long in practice but physically could be made narrower and shorter. Each web element 515 includes a plurality of nicks 520 that attach web element 515 to the two adjacent utensils 505 and join them all into a single set 525. For N number of rows, there will be N−1 web elements 515 used to form single set 525. All nicks 520 are disposed well away from the bowl-portion. Each forward location 530 where web element 515 meets an outer perimeter 535 of single set 525 is a possible location of a step discontinuity. In contrast to system 300, matrix system 500 is able to displace any step discontinuity more than 1 inch from the bowl-portion end of constructible utensil.

Because each N constructible utensils 505 produced each cycle are joined together in set 525 by matrix 510 which allows high-speed rotary printing, matrix system 500 is able to address a goal of cost-reducing individual constructible utensils to achieve retailer acceptance. Ensuring that any sharp protrusions are a minimum of one inch from a bowl-portion end of each constructible utensil enables matrix system 500 to address a goal of consumer acceptance, thus meeting market acceptance for constructible utensil 505.

In some instances, matrix system 500 may be improved because matrix 510 includes N−1 web elements 515 for each set 525. In some situations it can add cost to identify, locate, remove, and manage all the web elements as each web element 515 may require specialized attention from automated stripping equipment or use of manual labor to perform this task. This is one reason that web elements 515 are specified at a minimum of ⅛″ to better facilitate their removal. Improved removal systems enable reduction of the minimum thickness which further improves the costs.

FIG. 6 illustrates a first alternate matrix system 600 for high-speed rotary printing that addresses a potential drawback of matrix system 500. Matrix system 600 produces marketable constructible utensils 605 defined by a matrix 610. Matrix 610 is a single web element 615 including between-utensil components disposed between adjacent constructible utensils 605 that may be as narrow as ⅛″ in practice but physically could be made narrower, and a cross-utensil component disposed across all the handle portions and in-between utensil components. Web element 615 includes a plurality of nicks 620 that attach web element 615 to all utensils 605 and join them all into a single set 625. For N number of rows, web element 615 will include N−1 between-utensil components and one cross-utensil component to form single set 625. All nicks 620 are disposed well away from the bowl-portion, with matrix system 600 including a pair of nicks 620 attaching each handle portion to matrix 610. Each forward location 630 where web element 615 meets an outer perimeter 635 of single set 625 is a possible location of a step discontinuity. In contrast to system 300, first alternate matrix system 600 is able to displace any step discontinuity more than 1 inch from the bowl-portion end of constructible utensil.

Because each N constructible utensils 605 produced each cycle are joined together in set 625 by matrix 610 which allows high-speed rotary printing, matrix system 600 is able to address a goal of cost-reducing individual constructible utensils to achieve retailer acceptance. Ensuring that any sharp protrusions are a minimum of one inch from a bowl-portion end of each constructible utensil enables matrix system 600 to address a goal of consumer acceptance, thus meeting market acceptance for constructible utensil 605.

Matrix system 600 addresses a potential concern with matrix system 500 about individually removing all the discrete web elements. Matrix system 600 is able to do this because there is a single web element and all the between-utensil components (roughly corresponding to the individual web elements 515) are attached to cross-utensil component facilitating efficient stripping. Further, having fewer nicks 620 attaching between-utensil components to constructible utensil 605 helps to make removal of those components easier.

In some instances, matrix system 600 may be further improved because matrix 610 includes N−1 between-utensil components that may interfere with efficient stripping and because matrix 610 could be wasting web material as there is a minimum spacing between constructible utensils to support the removability of the between-utensil components.

FIG. 7 illustrates a second alternate matrix system 700 for high-speed rotary printing that addresses a potential drawback of matrix system 600 (as well as matrix system 500). Matrix system 700 produces marketable constructible utensils 705 defined by a matrix 710. Matrix 710 is a single strip of web element and dispenses with between-utensil components between adjacent constructible utensils 705. Matrix 710 includes four nicks 715 that attach the strip of web element to each constructible utensil 705 and join all constructible utensils 705 into a single set 720. Two of the four nicks 715 are connected to a handle end and the other two nicks are connected to opposing lateral edges of constructible utensil 705 very near the handle end. The two handle end nicks 715 would act as a hinge absent the lateral nicks that help to inhibit this hinging rotation between constructible utensils 705 and matrix 710. All nicks 715 are disposed well away from the bowl-portion. There is no forward location where the strip of web element meets an outer perimeter 725 of single set 720. A possible location of a step discontinuity does exist near the handle end near where the lateral nicks 715 are located, thus localizing both sharp protrusions in one area. In contrast to system 300, second alternate matrix system 700 is able to displace any step discontinuity much more than 1 inch from the bowl-portion end of constructible utensil.

Because each N constructible utensils 705 produced each cycle are joined together in set 720 by matrix 710 which allows high-speed rotary printing, matrix system 700 is able to address a goal of cost-reducing individual constructible utensils to achieve retailer acceptance. Ensuring that any sharp protrusions are a minimum of one inch from a bowl-portion end of each constructible utensil enables matrix system 700 to address a goal of consumer acceptance, which when combined with a satisfactory retailer acceptance, meets market acceptance for constructible utensil 705.

Matrix system 700 addresses a potential concern with first alternate matrix system 600 about between-utensil components being hard to remove and potentially wasting material. Matrix system 700 is able to do this because it removes all the between-utensil components greatly facilitating efficient stripping which allows closer spacing of constructible utensils 705 within set 720.

In some instances, matrix system 700 may be further improved because matrix 710 could be wasting web material as there is a minimum spacing between constructible utensils in order to shift the potential step discontinuity well away from the bowl-portion.

FIG. 8 illustrates a third alternate matrix system 800 for high-speed rotary printing that addresses a potential drawback of matrix system 700 (as well as matrix system 600 and matrix system 500). Matrix system 800 produces marketable constructible utensils 805 defined by a matrix 810. Matrix 810 is a single strip of web element that dispenses with between-utensil components between adjacent constructible utensils 805. Matrix 810 includes two nicks 815 that attach the strip of web element to each constructible utensil 805, as well as a set of nicks 815 between adjacent handle portions of constructible utensils 805 that collectively join all constructible utensils 805 into a single set 820. All nicks 815 are disposed well away from the bowl-portion. Where in other matrix systems there was a forward location where various cuts from steel rules would meet within the 1 inch minimum distance, matrix system 800 shifts the step discontinuity and resulting sharp protrusion by altering a perimeter of constructible utensil 805 wherever the sharp discontinuity is to be disallowed. Effectively a notch 825 in the outer perimeter (which alternatively could be created by widening of a portion of the handle perimeter) of each constructible utensil 805 shifts the step discontinuity towards the handle and away from the bowl-portion. In contrast to system 300, second alternate matrix system 700 is able to displace any step discontinuity more than 1 inch from the bowl-portion end of constructible utensil.

Because each N constructible utensils 805 produced each cycle are joined together in set 820 by matrix 810 which allows high-speed rotary printing, matrix system 800 is able to address a goal of cost-reducing individual constructible utensils to achieve retailer acceptance. Ensuring that any sharp protrusions are a minimum of one inch from a bowl-portion end of each constructible utensil enables matrix system 800 to address a goal of consumer acceptance, which when combined with a satisfactory retailer acceptance, meets market acceptance for constructible utensil 805.

Matrix system 800 addresses a potential concern with second alternate matrix system 700 about potentially wasting material due to the separation between constructible utensils in each set. Matrix system 800 is able to do this because it nicks handle portions of constructible utensil together and notches out a portion of the perimeter of constructible utensil 805 near the bowl-portion which allows closer spacing of constructible utensils 805 within set 820 while preserving consumer acceptance.

In some instances, matrix system 800 may be further improved because matrix 810 could be difficult to remove due to the small gap between the bowl-portions of constructible utensils 805 that shifts the potential step discontinuity away from the bowl-portion.

FIG. 9 illustrates a fourth alternate matrix system 900 for high-speed rotary printing that addresses a potential drawback of matrix system 800. Matrix system 900 produces marketable constructible utensils 905 defined by a virtual matrix 910. Virtual matrix 910 dispenses with between-utensil components between adjacent constructible utensils 905 and non-utensil connecting web elements in which a constructible utensil set is formed by directly nicking individual constructible utensils 905 together. Virtual matrix 910 includes a set of nicks 915 between adjacent handle portions of constructible utensils 905 that collectively join all constructible utensils 905 into a single set 920. All nicks 915 are disposed well away from the bowl-portion. Like matrix system 800, matrix system 900 shifts the step discontinuity and resulting sharp protrusion by altering a perimeter of constructible utensil 905 wherever the sharp discontinuity is to be disallowed. A much bigger notch 925 in the outer perimeter (which alternatively could be created by a greater widening of the portion of the handle perimeter) of each constructible utensil 905 by separating bowl-portions by ⅛″ or more shifts the step discontinuity towards the handle and away from the bowl-portion. In contrast to system 300, second alternate matrix system 900 is able to displace any step discontinuity more than 1 inch from the bowl-portion end of constructible utensil.

Because each N constructible utensils 905 produced each cycle are joined together in set 920 by virtual matrix 910 which allows high-speed rotary printing, matrix system 900 is able to address a goal of cost-reducing individual constructible utensils to achieve retailer acceptance. Ensuring that any sharp protrusions are a minimum of one inch from a bowl-portion end of each constructible utensil enables matrix system 800 to address a goal of consumer acceptance, which when combined with a satisfactory retailer acceptance, meets market acceptance for constructible utensil 905.

Matrix system 900 addresses a potential concern with third alternate matrix system 800 about potentially increasing stripping inefficiency due to the small spacing between the bowl-portions. Matrix system 900 is able to do this because it dispenses with any separate web element that needs to be stripped and creates a larger effective spacing between the bowl-portions which improves stripping efficiency of those pieces of the web material.

Matrix system 900 includes an optional score pattern component that is included in some of the incorporated patent documents. That optional score pattern component includes a lateral score 930 perpendicular to the longitudinal/fold axis that may be included with any of the constructible utensils described herein. Lateral score 930 allows constructible utensil 905 to fold, which makes it more compact when folded. In some instances managing a constructible utensil to efficiently fold it and apply semi-tacky adhesive maintaining the fold until a consumer unfolds it can be challenging and labor intensive. Holding several constructible utensils in a single set can facilitate the folding procedures and make it more manageable.

FIG. 10 illustrates a fifth alternate matrix system for high-speed rotary printing in which a different shaped constructible utensil 1005 is defined in a matrix 1010. One or more nicks 1015 (FIG. 10 illustrates a pair of nicks 1015 per constructible utensil 1005) hold constructible utensils 1005 into a single set.

FIG. 11 illustrates a sixth alternate matrix system 1100 for high-speed rotary printing of constructible utensil 1005 with a different matrix 1105 as compared to matrix 1005. Matrix 1105 “bumps” each constructible utensil 1005 into a shallow depression/notch in matrix 1105 to help stabilize the set. As before one or more nicks (e.g., 2 in FIG. 11) attach the handle portion of constructible utensil 1005 into the depression/notch and thus to matrix 1105.

FIG. 12 illustrates constructible utensil 1005 defined by the matrix system of FIG. 10 and FIG. 11; and FIG. 13 illustrates an alternate constructible utensil 1300 that may be defined by the disclosed matrix systems described herein, or modified by the disclosures of the incorporated patent documents.

Not only may the various constructible utensil styles described in the incorporated patent documents be adapted for high-speed printing as described herein, features and structures described herein may be applied to the alternate constructible utensil styles.

The matrix systems described herein, as well as other systems and methods of integrating several constructible utensils into a single set, offers another way to cost-reduce constructible utensils. Rather than stripping individual constructible utensils from the set-producing matrix, several sets may be packaged together and distributed to the retailer. Because the stripping process was not completed, the unit costs may be less but because the constructible utensils are in a set, they may be easily and efficiently handled and shipped. The retailer may have its workers perform the stripping operation at a total lower cost further saving money for the retailer and contributing to retailer acceptance.

While some of the figures include an identification of “feed direction” providing an indication of how the web moves through the high-speed printer. In some instances the feed direction may be different from what is illustrated.

Cost reduction provided by some of the disclosed embodiments improves as the physical size of the constructible utensil decreases. There are still advantages to be gained from the present invention even for larger utensils, for example the creation of sets of utensils and the processing and cost advantages that can result from their implementation and use. In some cases, sets may be implemented for lower speed manufacturing, such as sheet-fed printing.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. The apparatus substantially as disclosed herein.

2. The method substantially as disclosed herein.
